(19) United States
(12) Patent Application Publication
(10) Pub. No.: US 2009/0170391 A1
(43) Pub. Date: Jul. 2, 2009

(54) NOVEL PRODUCTS

(75) Inventor: Stephen Coulson, Oxfordshire (GB)

Correspondence Address: CONNOLLY BOVE LODGE & HUTZ, LLP, P O BOX 2207, WILMINGTON, DE, 19899, US

(73) Assignee: P2i Ltd., Oxfordshire (GB)

(21) Appl. No.: 12/161,038

(22) PCT Filed: Jan. 19, 2007
(86) PCT No.: PCT/GB07/00151

§ 371 Date: Nov. 19, 2008

Related U.S. Application Data
(60) Provisional application No. 60/762,241, filed on Jan. 26, 2006.

(30) Foreign Application Priority Data
Jan. 20, 2006 (GB) 0601115.9
Oct. 30, 2006 (GB) 0621484.5
Nov. 22, 2006 (GB) 0623219.3

(51) Int. Cl. B32B 27/12; D06M 10/10; B32B 37/00

(52) U.S. Cl. 442/152; 427/490; 442/164; 156/275.5

(57) ABSTRACT

An item selected from a piece of fashion clothing, a clothing accessory or a household textile having a polymeric coating, formed by exposing said item or a material or yarn from which the item is subsequently constructed, to a pulsed plasma comprising a compound of formula (I)

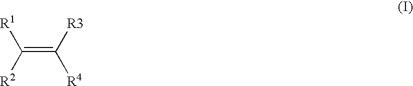

where R¹, R², R³ and l⁴ are defined in the specification for a sufficient period of time to allow a polymeric layer to form on the surface of the item or yarn. Items of this type are protected from contamination by a wide number of liquids, including environmental hazards such as rain water and water-based liquids as well as some oily liquids. They are also fade and odour resistant.

The present invention relates to novel products in the form of fashion products and accessories, which are treated to protect them from liquid damage, for example from environmental liquid damage in addition to protection from liquid spills in particular from water or other water based liquids and some oil products, as well as to processes for their production.

Fashion accessories, fashion apparel and household textiles, particularly those with designer labels, are frequently high value items. They are subject to considerable wear and tear, in particular from environmental liquids such as rain and spray, and from accidental spillage of liquids including oily liquids. This is particularly true of items such as shoes including in particular sports shoes, but equally well applies to accessories such as bags such as handbags, sports bags and briefcases, ties, cravats, hats, scarves and umbrellas.

The fabrics from which some of the high value clothing items are constructed are often very sensitive to such contamination, but also are difficult to clean effectively. Particular examples include for instance silks, satins, wool including cashmere or wool blends, and leather or suede but also some quality or fine cottons such as linens, and synthetic fabric such as polyester type fabrics, including voiles, such as are utilised in fashion clothing. Cleaning is frequently a difficult and expensive problem, particularly for items such as wedding dresses, ball gowns, cocktail dresses or fashion clothing. In some cases, cleaning by any means is not possible.

Plasma deposition techniques have been used for the deposition of polymeric coatings onto a range of surfaces, and in particular onto fabric surfaces. This technique is recognised as being a clean, dry technique that generates little waste compared to conventional wet chemical methods. Using this method, plasmas are generated from organic molecules, which are subjected to an electrical field. When this is done in the presence of a substrate, the radicals of the compound in the plasma polymerise on the substrate. Conventional polymer synthesis tends to produce structures containing repeat units that bear a strong resemblance to the monomer species, whereas a polymer network generated using a plasma can be extremely complex. The properties of the resultant coating can depend upon the nature of the substrate as well as the nature of the monomer used and conditions under which it is deposited.

Whilst such techniques have been used before in relation to items of clothing, for example, military uniforms or heavy duty outdoor clothing and the like, where oil and water repellency is an important and useful parameter, it has not been applied broadly to fashion items, where the handling and appearance as well as the drape and feel properties of the fabrics are important.

The applicants have found that by utilising a specific type of monomer under particular deposition conditions, clothing and footwear generally as well as fashion accessories having highly liquid repellent nano-coatings thereon can be produced. The treated materials show further significant advantages including being odour and fade resistant, even when subjected to repeated dry cleaning processes.

According to the present invention there is provided an item selected from a piece of fashion or sports clothing, a clothing accessory or a household textile having a polymeric coating, formed by exposing said item or a material or yarn from which the item is constructed, to a pulsed plasma comprising a compound of formula (I)

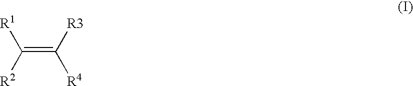

where R¹, R² and R³ are independently selected from hydrogen, alkyl, haloalkyl or aryl optionally substituted by halo; and R⁴ is a group X—R⁵ where R⁵ is an alkyl or haloalkyl group and X is a bond; a group of formula —C(O)O—, —C(O)O(CH₂)ₙY— where n is an integer of from 1 to 10 and Y is a bond or a sulphonamide group; or a group —(O)ₚR⁶(O)_{q}(CH₂)ₜ— where R⁶ is aryl optionally substituted by halo, p is 0 or 1, q is 0 or 1 and t is 0 or an integer of from 1 to 10, provided that where q is 1, t is other than 0, for a sufficient period of time to allow a protective polymeric layer to form on the surface of the item or yarn.

The polymeric layer may confer oil and/or water repellent properties on the item. However, surprisingly, neither the feel or the appearance or general properties of items are affected by the procedure described herein. However, the polymer layer is robust enough to withstand cleaning procedures such as dry cleaning. Furthermore, it has been noted that the colours of the fabrics or materials are less likely to fade or diminish than in the corresponding untreated fabrics or materials. This suggests that the coatings are protecting the dyes, making them more fast within the fabrics and acting as an anti-fade coatings.

In the case of shoes, the coating is sufficiently robust to make the shoes appear ‘water-proof’, in spite of the levels of hard wear-and-tear to which such items are subjected. This is particularly useful in the case of sports shoes or trainers, where previous attempts to prevent ingress of water in use has focused on the use of water-impermeable membranes such as Gore-tex™ membranes. The problem with such membranes is that they restrict significantly the flow of air also, meaning the sweat is unable to evaporate effectively, and so the shoes to become uncomfortable or unpleasant in use.

The process described herein, when applied to porous material such as fabrics or leather, does not block up the pores of the fabric but modifies the individual fibres, so that they repel liquid. Overall, this means that the material repels liquid, and so the result item such as the sports shoe, will appear, in most normal circumstances to the waterproof. However, the air can still pass freely through the pores, allowing the shoes and the like to “breathe”. Similar advantages apply to technical sports clothing such as sports shorts, tee-shirts, training trousers and tops.

A further advantage which has been noted in relation to materials which have been treated as described herein is that they are less prone to odours. This is particularly advantageous in relation to workwear or shoes including sports shoes where normal wear and tear means that they are prone to contamination with body fluids such as sweat which give rise to unpleasant odours. In the case of shoes, this may avoid the need to introduce specific odour inhibiting insoles and the like. However, it has further been noted that the fabrics and materials are less likely to absorb odours or contaminants from the environment, such as smoke and in particular cigarette smoke, fumes such as traffic fumes or other strong invasive smells such as may be found in particular working environments such as may be found for example around harbours or fish markets, in agriculture and farming such as mushroom farming and animal husbandry.

These additional effects (odour resistance and fade resistance) are of great benefit in relation to many forms of clothing including items which may not necessarily be regarded as “fashion clothing” such as workwear and the like. They may be particularly useful in relation to clothing accessories, which may be required to be worn or used repeatedly without cleaning on each occasion.

As used herein, the expression “in a gaseous state” refers to gases or vapours, either alone or in mixture, as well as aerosols.

The expression “protective polymeric layer” refers to polymeric layers which provide some protection against liquid damage, and in particular are liquid (such as oil- and water-) repellent. Sources of liquids from which the items are protected include environmental liquids such as water, and in particular rain, as well as any other oil or liquid, which may be accidentally spilled.

As used herein, the term “an item of fashion clothing” refers to items of clothing intended for use by the public, including dresses, and particularly high fashion, value or quality dresses such as wedding dresses, ball gowns, cocktail dresses or haute couture dresses, shirts, blouses, sweaters or cardigans, trousers, jackets including dinner jackets, suits or shell suits as well as technical sports clothing.

As used herein, the term “clothing accessory” refers to footwear including shoes, technical sports shoes, boots including hiking boots, and trainers, bags including luggage, briefcases, handbags, sports bags and purses, belts, gloves, ties, scarves, cravats, umbrellas and hats or any other natural or synthetic textile or leather item.

As used herein, the term “household textile” refers to items of household linen such as table linen such as table cloths or napkins, bed linen including sheets, quilts, duvets and duvet covers, curtains or drapes or carpets or rugs.

The term “wool blend” refers to woollen materials which represent a combination of different wool types, such as lambswool and cashmere, or a combination of wool with a synthetic material such as a polyester, acrylate or nylon.

Generally, the items treated will be at least partly made of a fashion material such as silks, satins, wool including cashmere or wool blends, and leather or suede, fine cottons such as linens, or a fine synthetic fabric such as a polyester or voile, as is used in the fashion industry.

In a particular embodiment the item is an item of fashion clothing, which is selected from a wedding dress, a ball gown, a cocktail dress or an haute couture dress. With such items, the appearance, feel and in particular the drape or folding properties of the fabric are essential to achieve the designer and wearer's requirements. Treatment of the item in accordance with the process defined above does not impact on these properties in any significant way.

Materials from which dresses can be made include silks, satins, wool including cashmere or wool blends, cottons, including linen and synthetic fabric such as polyester type fabrics. In particular, the dress is of a high value or delicate fabric such as silk or satin or voile.

In an alternative embodiment, the item is a fashion separate such as a shirt, blouse, trouser or jacket, and particularly a item produced by an haute couture fashion house. Materials from which these can be made include silks, satins, wool including cashmere or wool blends, and leather or suede, cottons including linen and synthetic fabric such as polyester type fabrics. In particular, the separate is of a high value fabric such as silk, satin, cashmere or leather.

Again, the appearance, feel and in particular the drape or folding properties of the fabric may be essential to achieve the designer and wearer's requirements, and treatment as described herein; produces items which are strongly water- and oil repellent, but which, in appearance and “wear quality”, are unaffected.

A further particular example of an item of fashion clothing is a shell suit and similar items made from fabrics with a particular appearance or sheen. In this case, the particular appearance and sheen of the fabric is an important fashion aspect, and this remains unchanged as a result of the treatment described herein.

Woollen or wool blend items are also examples of fashion clothing which may be treated as described herein. The feel of these items, particularly if worn next to the skin, such as sweaters or cardigans is very important, and the treatment described herein does not affect this. Sweaters and cardigans made from cotton or synthetic materials or mixtures of these may also benefit from this treatment.

In one embodiment, the material or yarn from which the above-described items of fashion clothing are made is treated prior to formation of the item.

Suitably however, the final item is exposed to the plasma as described above, as in this case, the seam areas are fully protected.

In a further embodiment, the item is a clothing accessory.

Particular examples of clothing accessories are items of footwear. These are generally prepared from a range of different materials including leather, plastics, fabrics and rubber. Fashion shoes in particular may further comprise ornamentation which may be of plastics or metal, or fabrics used may include metallic threads. Treatment as described herein can be used to render the entire shoe water and oil-repellent, irrespective of the nature of the substrate and the areas where these are located. Again, the individual materials or used to produce those materials may be treated individually, but in a particularly suitable embodiment, the assembled shoe is subject to treatment. In effect, the treatment can be used to seal the seams of the footwear, thus acting as a tapeless seam sealer which confers effective water resistance on footwear. As a result, it may be used instead of the tape type seam sealers which are sometimes applied to footware in particular, but to other types of seam also, to ensure that the treated item is water resistance.

Particular examples of shoes are fashion shoes or fashion trainers, and in particular those produced by haute couture fashion houses and sports and active wear companies. In this instance, the fact that the treatment has no impact on the appearance and feel of the shoes is the most important factor as well as removing the need to include barrier materials; further improving the comfort.

Other particular examples of such shoes are hard-wearing outdoor shoes or boots such as hiking boots. The excellent water and oil repellency of these items when treated as described herein is extremely useful in this context.

Other particular examples of fashion accessories are bags including luggage, briefcases, handbags, particularly fashion handbags, sports bags and purses. These are frequently made of leather, plastics or fabrics, and in use, may be exposed to significant environmental damage from rain. The treatment described herein can be applied to all these materials without altering their appearance or feel. Again, the individual materials or used to produce those materials may be treated individually, but in a particularly suitable embodiment, the assembled bag is subject to treatment, to ensure that any seam areas are fully protected.

Accessories such as ties, scarves and cravats may be treated in accordance with the invention. In this case, as a result of the lack of exposed seams, it may be as effective to treat the material from which they are prepared or the yarn used in the production of this material as the finished item. Particular materials for ties and cravats are silks and synthetic fabrics such as polyesters, whilst scarves may be of wool, wool blends or synthetic fabrics such as polyesters. Treatment as described herein, means that these items will require cleaning less frequently, and are easier to clean effectively when this is required.

Items such as umbrellas and hats, which are generally exposed to environmental water such as rain provide higher levels of protection, and may have a longer useful life as a result of treatment as described herein.

In a further embodiment, the item is a household textile. Table linen in particular such as table cloths or napkins, which are usually made of cottons (including linen) or synthetic fabrics such as polyester, are subject to accidental spillage, frequently of highly coloured or staining substances such as condiments and wine. Again, treatment as described herein means that these spillages can be mopped up relatively easily with a reduced risk of permanent staining.

Bed linen including sheets, quilts, duvets and duvet covers, such as those made or cotton such as linen or synthetic material such as polyester, may also be subject to treatment as described herein to assist in keeping these clean and stain free, whilst not altering the feel of the fabric. Duvets or quilts in particular, those that are filled with sensitive materials such as down, which require specialised cleaning, benefit from this treatment as the frequency with which this cleaning is required may be reduced.

Similar considerations apply to curtains or drapes, as well as carpets or rugs. In the case of these items which may be large, but which do not have abundant or exposed seams, the materials from which they are made, such as cottons, wool, wool blends or synthetic materials such as polyesters, or the yarns used to produce these may be advantageously treated as described herein.

Precise conditions under which the plasma polymerization takes place in an effective manner will vary depending upon factors such as the nature of the polymer, the item being treated etc. and will be determined using routine methods and/or the techniques.

Suitable plasmas for use in the method described herein include non-equilibrium plasmas such as those generated by radiofrequencies (Rf), microwaves or direct current (DC). They may operate at atmospheric or sub-atmospheric pressures as are known in the art. In particular however, they are generated by radiofrequencies (Rf).

Various forms of equipment may be used to generate gaseous plasmas. Generally these comprise containers or plasma chambers in which plasmas may be generated. Particular examples of such equipment are described for instance in WO2005/089961 and WO02/28548, the contents of which are incorporated herein by reference, but many other conventional plasma generating apparatus are available.

In general, the item to be treated is placed within a plasma chamber together with the material to be deposited in gaseous state, a glow discharge is ignited within the chamber and a suitable voltage is applied, which may be pulsed.

The gas used within the plasma may comprise a vapour of the monomeric compound alone, but it may be combined with a carrier gas, in particular, an inert gas such as helium or argon. In particular helium is a preferred carrier gas as this can minimises fragmentation of the monomer.

When used as a mixture, the relative amounts of the monomer vapour to carrier gas is suitably determined in accordance with procedures which are conventional in the art. The amount of monomer added will depend to some extent on the nature of the particular monomer being used, the nature of the laboratory disposable being treated, the size of the plasma chamber etc. Generally, in the case of conventional chambers, monomer is delivered in an amount of from 50-250 mg/min, for example at a rate of from 100-150 mg/min. Carrier gas such as helium is suitably administered at a constant rate for example at a rate of from 5-90, for example from 15-30 sccm. In some instances, the ratio of monomer to carrier gas will be in the range of from 100:1 to 1:100, for instance in the range of from 10:1 to 1:100, and in particular about 1:1 to 1:10. The precise ratio selected will be so as to ensure that the flow rate required by the process is achieved.

Alternatively, the monomer may be delivered into the chamber by way of an aerosol device such as a nebuliser or the like, as described for example in WO2003/097245 and WO03/101621, the content of which is incorporated herein by reference.

In some cases, a preliminary continuous power plasma may be struck for example for from 2-10 minutes for instance for about 4 minutes, within the chamber. This may act as a surface pre-treatment step, ensuring that the monomer attaches itself readily to the surface, so that as polymerisation occurs, the coating “grows” on the surface. The pretreatment step may be conducted before monomer is introduced into the chamber, in the presence of only the inert gas.

The plasma is then suitably switched to a pulsed plasma to allow polymerisation to proceed, at least when the monomer is present.

In all cases, a glow discharge is suitably ignited by applying a high frequency voltage, for example at 13.56 MHz. This is suitably applied using electrodes, which may be internal or external to the chamber, but in the case of the larger chambers are internal.

Suitably the gas, vapour or gas mixture is supplied at a rate of at least 1 standard cubic centimetre per minute (sccm) and preferably in the range of from 1 to 100 sccm.

In the case of the monomer vapour, this is suitably supplied at a rate of from 80-300 mg/minute, for example at about 120 mg per minute depending upon the nature of the monomer, whilst the pulsed voltage is applied.

Gases or vapours may be drawn or pumped into the plasma region. In particular, where a plasma chamber is used, gases or vapours may be drawn into the chamber as a result of a reduction in the pressure within the chamber, caused by use of an evacuating pump, or they may be pumped or injected into the chamber as is common in liquid handling.

Polymerisation is suitably effected using vapours of compounds of formula (I), which are maintained at pressures of from 0.1 to 200 mtorr, suitably at about 80-100 mtorr.

The applied fields are suitably of power of from 40 to 500 W, suitably at about 100 W peak power, applied as a pulsed field.

The pulses are applied in a sequence which yields very low average powers, for example in a sequence in which the ratio of the time on:time off is in the range of from 1:500 to 1:1500. Particular examples of such sequence are sequences where power is on for 20-50 μs, for example about 30 μs, and off for from 1000 μs to 30000 μs, in particular about 20000 μs. Typical average powers obtained in this way are 0.01 W.

The fields are suitably applied from 30 seconds to 90 minutes, preferably from 5 to 60 minutes, depending upon the nature of the compound of formula (I) and the item being treated etc.

Suitably a plasma chamber used is of sufficient volume to accommodate multiple items, for example up to 100 pairs of shoes or 8 jackets at the same time.

A particularly suitable apparatus and method for producing items in accordance with the invention is described in WO2005/089961, the content of which is hereby incorporated by reference.

In particular, when using high volume chambers of this type, the plasma is created with a voltage as a pulsed field, at an average power of from 0.001 to 500 w/m³, for example at from 0.001 to 100 w/m³ and suitably at from 0.005 to 0.5 w/m³.

These conditions are particularly suitable for depositing good quality uniform coatings, in large chambers, for example in chambers where the plasma zone has a volume of greater than 500 cm³, for instance 0.5 m³ or more, such as from 0.5 m³-10 m³ and suitably at about 1 m³. The layers formed in this way have good mechanical strength.

The dimensions of the chamber will be selected so as to accommodate the particular item being treated. For instance, generally cuboid chambers may be suitable for a wide range of applications, but if necessary, elongate or rectangular chambers may be constructed or indeed cylindrical, or of any other suitable shape.

The chamber may be a sealable container, to allow for batch processes, or it may comprise inlets and outlets for the items, material or yarn, to allow it to be utilised in a continuous process. In particular in the latter case, the pressure conditions necessary for creating a plasma discharge within the chamber are maintained using high volume pumps, as is conventional for example in a device with a “whistling leak”. However it will also be possible to process certain items at atmospheric pressure, or close to, negating the need for “whistling leaks”

The monomers used are selected from monomers of formula (I) as defined above. Suitable haloalkyl groups for R¹, R², R³ and R⁵ are fluoroalkyl groups. The alkyl chains may be straight or branched and may include cyclic moieties.

For R⁵, the alkyl chains suitably comprise 2 or more carbon atoms, suitably from 2-20 carbon atoms and preferably from 6 to 12 carbon atoms.

For R¹, R² and R³, alkyl chains are generally preferred to have from 1 to 6 carbon atoms.

Preferably R⁵ is a haloalkyl, and more preferably a perhaloalkyl group, particularly a perfluoroalkyl group of formula CₘF_{2 m+1} where m is an integer of 1 or more, suitably from 1-20, and preferably from 4-12 such as 4, 6 or 8.

Suitable alkyl groups for R¹, R² and R³ have from 1 to 6 carbon atoms.

In one embodiment, at least one of R¹, R² and R³ is hydrogen. In a particular embodiment R¹, R², R³ are all hydrogen. In yet a further embodiment however R³ is an alkyl group such as methyl or propyl.

Where X is a group —C(O)O— —C(O)O(CH₂)ₙY—, n is an integer which provides a suitable spacer group. In particular, n is from 1 to 5, preferably about 2.

Suitable sulphonamide groups for Y include those of formula —N(R⁷)SO₂⁻ where R⁷ is hydrogen or alkyl such as C₁₋₄alkyl, in particular methyl or ethyl.

In one embodiment, the compound of formula (I) is a compound of formula (II)

CH₂═CH—R⁵ (II)

where R⁵ is as defined above in relation to formula (I).

In compounds of formula (II), X in formula (I) is a bond.

However in a preferred embodiment, the compound of formula (I) is an acrylate of formula (III)

CH₂═CR⁷C(O)O(CH₂)ₙR⁵ (III)

where n and R⁵ as defined above in relation to formula (I) and R⁷ is hydrogen, C₁₋₁₀ alkyl, or C₁₋₁₀haloalkyl. In particular R⁷ is hydrogen or C₁₋₆alkyl such as methyl. A particular example of a compound of formula (III) is a compound of formula (IV)

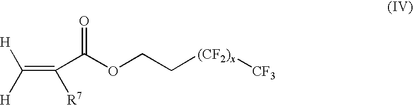

where R⁷ is as defined above, and in particular is hydrogen and x is an integer of from 1 to 9, for instance from 4 to 9, and preferably 7. In that case, the compound of formula (IV) is 1H, 1H, 2H, 2H-heptadecafluorodecylacylate.

In a further aspect, the invention provides a method for protecting an item selected from a piece of fashion clothing, a clothing accessory or a household textile against liquids, for example environmental liquids or accidentally spilled liquids, said method comprising exposing said item or a material or yarn from which the item is to be made, to a pulsed plasma comprising a compound of formula (I)

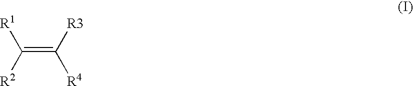

where R¹, R² and R³ are independently selected from hydrogen, alkyl, haloalkyl or aryl optionally substituted by halo; and R⁴ is a group X—R⁵ where R⁵ is an alkyl or haloalkyl group and X is a bond; a group of formula —C(O)O, —C(O)O(CH₂)ₙY— where n is an integer of from 1 to 10 and Y is a bond or a sulphonamide group; or a group —(O)ₚR⁶(O)_{q}(CH₂)ₜ— where R⁶ is aryl optionally substituted by halo, p is 0 or 1, q is 0 or 1 and t is 0 or an integer of from 1 to 10, provided that where q is 1, t is other than 0,
in a gaseous state for a sufficient period of time to allow a polymeric layer to form on the surface of the item, material or yarn.

In a further aspect, the invention provides a method for making an item odour resistant, said method comprising exposing said item or a material or yarn from which the item is to be made, to a pulsed plasma comprising a compound of formula (I)

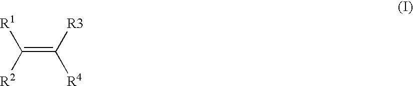

where R¹, R² and R³ are independently selected from hydrogen, alkyl, haloalkyl or aryl optionally substituted by halo; and R⁴ is a group X—R⁵ where R⁵ is an alkyl or haloalkyl group and X is a bond; a group of formula —C(O)O—, —C(O)O(CH₂)ₙY— where n is an integer of from 1 to 10 and Y is a bond or a sulphonamide group; or a group —(O)ₚR⁶(O)_{q}(CH₂)ₜ— where R⁶ is aryl optionally substituted by halo, p is 0 or 1, q is 0 or 1 and t is 0 or an integer of from 1 to 10, provided that where q is 1, t is other than 0, in a gaseous state for a sufficient period of time to allow a polymeric layer to form on the surface of the item, material or yarn.

In this instance the item may be any item of clothing including working wear such as overalls or the like, as well as a piece of fashion clothing, a clothing accessory or a household textile as described herein. The odours which the item becomes resistant to may be the result of use of the item, for example sweat absorbed when the item is worn and so is particularly useful in relation to items such as shoes or fashion clothing. Alternatively, the item may be made more resistant to odours resulting from environmental contamination such as smoke in particular cigarette or cigar smoke, which may be a particular problem in some environments such as public houses and the like, fumes such as traffic fumes, or other unpleasant odours as may be encountered in particular locations or work environments as discussed above.

In yet a further aspect, the invention provides a method for enhancing the fade resistance or colour fastness of an item, said method comprising exposing said item or a material or yarn from which the item is to be made, to a pulsed plasma comprising a compound of formula (I)

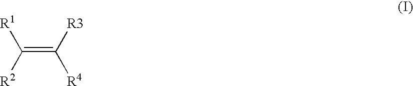

where R¹, R² and R³ are independently selected from hydrogen, alkyl, haloalkyl or aryl optionally substituted by halo; and R⁴ is a group X—R⁵ where R⁵ is an alkyl or haloalkyl group and X is a bond; a group of formula —C(O)O—, —C(O)O(CH₂ )ₙY— where n is an integer of from 1 to 10 and Y is a bond or a sulphonamide group; or a group —(O)ₚR⁶(O)_{q}(CH₂)ₜ— where R⁶ is aryl optionally substituted by halo, p is 0 or 1, q is 0 or 1 and t is 0 or an integer of from 1 to 10, provided that where q is 1, t is other than 0,
in a gaseous state for a sufficient period of time to allow a polymeric layer to form on the surface of the item, material or yarn.

In this instance the item may be any item of clothing or fabric which is subject to for example repeated dry cleaning procedures. This may be particularly applicable to items of fashion clothing or a household textile such as upholstery fabrics etc.

Suitably, the item, material or yarn to be treated in these methods is placed in a plasma deposition chamber, a glow discharge is ignited within said chamber, and a voltage applied as a pulsed field.

Suitable monomers and reaction conditions for use in this method are as described above.

The invention will now be particularly described by way of example.

### EXAMPLE 1

### Shoes

2 pairs of fashion shoes were placed into a plasma chamber with a processing volume of ˜300 litres. The chamber was connected to supplies of the required gases or vapours, via a mass flow controller and/or liquid mass flow meter and a mixing injector as appropriate.

The chamber was evacuated to between 3-10 mtorr base pressure before allowing helium into the chamber at 20 sccm until a pressure of 80 mtorr was reached. A continuous power plasma was then struck for 4 minutes using RF at 13.56 MHz at 300 W.

After this period, 1H,1H,2H,2H-heptadecafluorodecylacylate (CAS # 27905-45-9) of formula

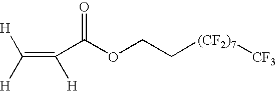

was brought into the chamber at a rate of 120 milli grams per minute and the plasma switched to a pulsed plasma at 30 micro seconds on-time and 20 milli seconds off-time at a peak power of 100 W for 40 minutes. On completion of the 40 minutes the plasma power was turned off along with the processing gases and vapours and the chamber evacuated back down to base pressure. The chamber was then vented to atmospheric pressure and the shoes removed.

It was found that the shoes were covered with an water and oil-repellent that protected it from challenge with water.

1. An item selected from the group consisting of a piece of fashion or sports clothing, a clothing accessory and a household textile, the item comprising a polymeric coating formed by exposing the item, or a material or a yarn from which the item is constructed, to a pulsed plasma comprising a compound of formula (I) 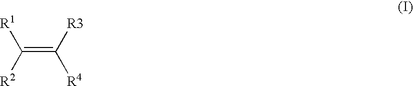
wherein R¹, R² and R³ are independently selected from hydrogen, alkyl, haloalkyl or aryl optionally substituted by halo; and R⁴ is a group X—R⁵ where R⁵ is an alkyl or haloalkyl group and X is a bond; a group of formula —C(O)O—, —C(O)O(CH₂)ₙY— where n is an integer of from 1 to 10 and Y is a bond or a sulphonamide group; or a group —(O)ₚR⁶(O)_{q}(CH₂)— where R⁶ is aryl optionally substituted by halo, p is 0 or 1, q is 0 or 1 and t is 0 or an integer of from 1 to 10, provided that where q is 1, t is other than 0, for a sufficient period of time to allow a protective polymeric layer to form on the surface of the item, material or yarn.

2. The item of claim 1 which comprises a material selected from silk, satin, wool or wool blends, leather or suede, fine cottons or a fine synthetic fabric.

3. The item of claim 1 which is a piece of fashion clothing.

4. An item according to claim 1 or claim 2 The item of claim 1 which is a clothing accessory.

5. The item of claim 4 which comprises footwear or a handbag.

6. The item of claim 5 which comprises technical sports shoes.

7. (canceled)

8. The item of claim 1 wherein the item or the material or the yarn is exposed to the pulsed plasma within a plasma deposition chamber.

9. The item of claim 1 wherein the compound of formula (I) is a compound of formula (II)
CH₂═CH—R⁵ (II)
wherein R⁵ is as defined in claim 1, or a compound of formula (III)
CH₂═CR⁷C(O)O(CH₂)ₙR⁵ (III)
wherein n and R⁵ are as defined in claim 1 and R⁷ is hydrogen, C₁₋₁₀ alkyl, or C₁₋₁₀haloalkyl.

10. The item of claim 9 wherein the compound of formula (I) is a compound of formula (III).

11. The item of claim 10 wherein the compound of formula (III) is a compound of formula (IV) 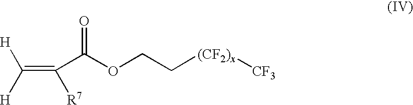
wherein R⁷ is as defined in claim 8 is hydrogen, C₁₋₁₀ alkyl, or C₁₋₁₀haloalkyl, and x is an integer of from 1 to 9.

12. The item of claim 10 wherein the compound of formula (IV) is 1H,1H,2H,2H-heptadecafluorodecylacylate.

13. A method for protecting an item selected from a piece of fashion clothing, a clothing accessory or a household textile, against liquid damage, odour contamination or colour fading, said method comprising exposing said item or a material or yarn from which the item is to be made, to a pulsed plasma comprising a compound of formula (I) 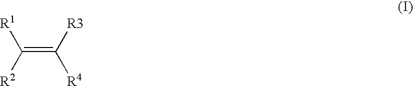
where R¹, R² and R³ are independently selected from hydrogen, alkyl, haloalkyl or aryl optionally substituted by halo; and
R⁴ is a group X—R⁵ where R⁵ is an alkyl or haloalkyl group and X is a bond; a group of formula —C(O)O—, —C(O)O(CH₂)ₙY— where n is an integer of from 1 to 10 and Y is a bond or a sulphonamide group; or a group —(O)ₚR⁶(O)_{q}(CH₂)ₜ— where R⁶ is aryl optionally substituted by halo, p is 0 or 1, q is 0 or 1 and t is 0 or an integer of from 1 to 10, provided that where q is 1, t is other than 0,
in a gaseous state for a sufficient period of time to allow a polymeric layer to form on the surface of the item, material or yarn.

14-15. (canceled)

16. The method of claim 13 wherein the item, material or yarn is placed in a plasma deposition chamber, a glow discharge is ignited within said chamber, and a voltage is applied as a pulsed field.

17. The method of claim 13 wherein applied voltage is at a power of from 40 to 500 W.

18. The method of claim 13 wherein the voltage is pulsed in a sequence in which the ratio of the time on:time off is in the range of from 1:500 to 1:1500.

19. The method of claim 18 wherein the voltage is pulsed in a sequence where power is on for 20-50 μs, and off for from 1000 μs to 30000 μs.

20. The method of claim 13 wherein the voltage is applied as a pulsed field at for a period of from 30 seconds to 90 minutes.

21. (canceled)

22. The method of claim 13 wherein in a preliminary step, a continuous power plasma is applied to the item, material or yarn.

23. The method of claim 22 wherein the preliminary step is conducted in the presence of an inert gas.

24. The method of claim 13 wherein the compound of formula (I) in gaseous form is fed into the plasma at a rate of from 80-300 mg/minute, whilst the pulsed voltage is applied.

25. The method of claim 13 wherein the plasma is created with a voltage at an average power of from 0.001 to 500 w/m³.

26. The method of claim 25 wherein the plasma is created with a voltage at an average power of from 0.001 to 100 w/m³.

27. The method of claim 26 wherein the plasma is created with a voltage at an average power of from 0.005 to 0.5 w/m³.

28. The method of claim 13 wherein the compound of formula (I) is a compound of formula (II)
CH₂═CH—R⁵ (II)
wherein R⁵ is as defined in claim 1, or a compound of formula (III)
CH₂═CR⁷C(O)O(CH₂)ₙR⁵ (III)
wherein n and R⁵ as defined in claim 1 and R⁷ is hydrogen, C₁₋₁₀ alkyl, or C₁₋₁₀haloalkyl.

29. The method of claim 28 wherein the compound of formula (I) is a compound of formula (III).

30. The method of claim 29 wherein the compound of formula (III) is a compound of formula (IV) 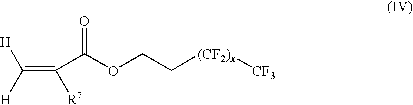
wherein R⁷ is hydrogen, C₁₋₁₀ alkyl, or C₁₋₁₀haloalkyl, and x is an integer of from 1 to 9.

31. The method of claim 28 wherein the compound of formula (IV) is 1H,1H,2H,2H-heptadecafluorodecyl acrylate.

32. (canceled)

33. A method for creating a tapeless seam sealer in an item comprising a seam, the method comprising exposing the item to a pulsed plasma in a gaseous state for a sufficient period of time to seal the seam of the item, the pulsed plasma comprising a compound of formula (I) 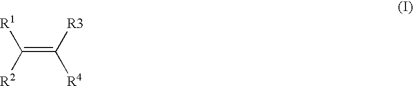
wherein R¹, R² and R³ independently are selected from hydrogen, alkyl, haloalkyl or aryl, optionally substituted by halo; and
R⁴ is a group X—R⁵ wherein R⁵ is an alkyl or haloalkyl group and X is a bond; or R⁴ is a group of formula —C(O)O—, —C(O)O(CH₂)ₙY— wherein n is an integer from 1 to 10 and Y is a bond or a sulphonamide group; or R⁴ is a group —(O)ₚR⁶(O)_{q}(CH₂)ₜ— wherein R⁶ is aryl optionally substituted by halo, p is 0 or 1, q is 0 or 1 and t is 0 or an integer from 1 to 10, provided that where q is 1, t is other than 0.

34. An item comprising a seam and selected from the group consisting of a fashion or sports clothing, a clothing accessory and a household textile, wherein the seam is sealed by a polymeric coating obtained by the method of claim 33.
